(19) United States
(12) Patent Application Publication
(10) Pub. No.: US 2007/0106664 A1
(43) Pub. Date: May 10, 2007

(54) Input/query methods and apparatuses

(75) Inventors: Derek Huang, Shanghai (CN); Alvin Wang Graylin, Bellevue, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: mInfo, Inc.

(21) Appl. No.: 11/266,912

(22) Filed: Nov. 4, 2005

(51) Int. Cl. G06F 17/30

(52) U.S. Cl. 707/6

(57) ABSTRACT

Methods and apparatuses for processing query are disclosed herein, including embodiments configured to facilitate submission of a query expressed in a pseudo-natural language or mixed-language statement, embodiments configured to facilitate responding to queries with limited display capabilities, and embodiments configured to facilitate both.

### TECHNICAL FIELD

Embodiments of the present invention relate to the field of data processing, in particular, to input/query methods for apparatuses with limited input and/or display capabilities.

### BACKGROUND

Ever since the dawn of computing, computer scientists and system designers have strived to make data more readily and/or easily accessible to end users. Over the years, database designers have developed formal database query languages, such as the Structured Query Language (SQL), to make data more readily and/or easily accessible to application developers. In turn, application developers have developed query facilities, such as Query-By-Example and natural language query for end users to input and access data directly.

With advances in microprocessor, networking, and other related technologies leading to wide spread deployment and adoption of powerful general purpose as well as special purpose portable computing and communication devices, such as wireless mobile phones, system designers are facing new challenges in making data readily and/or easily accessible. Typically, portable computing and communication devices, especially when compared to laptop and desktop computers, are more limited in input and/or display capabilities.

Likewise, system designers designing controllers to control advanced special purpose digital components, such as set-top boxes, game consoles, and so forth, are also facing similar challenges.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of the input/query methods and apparatuses of the invention, in accordance with various embodiments;

FIG. 2 illustrates query processing unit of FIG. 1 in further details, in accordance with various embodiments;

FIG. 3 illustrates an example computer readable medium, suitable for use to facilitate practice of the present invention, in accordance with various embodiments.

### DETAILED DESCRIPTION OF ILLUSTRATIVE EMBODIMENTS

Illustrative embodiments of the present invention include but are not limited to input/query methods and apparatuses, in particular, input/query methods for computing or communication devices with relatively more limited input and/or display capabilities, such as wireless mobile phones.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(A B) or (B)”, that is “A” is optional.

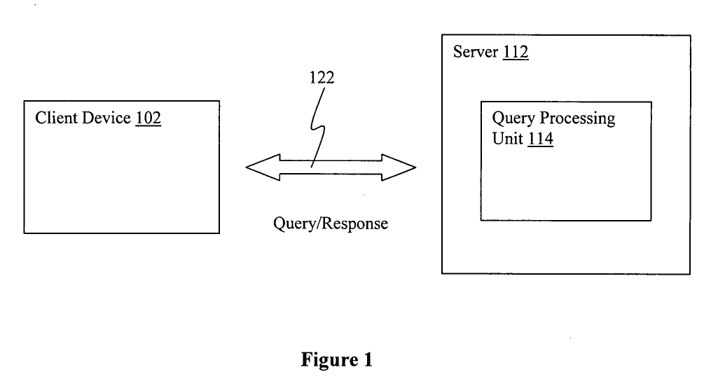

Referring now to FIG. 1, wherein a block diagram illustrating an overview of the present invention, in accordance with various embodiments, is shown. As illustrated, for the embodiments, the input/query method of the present invention enables a user to readily and/or easily access data, employing client device 102, which may be (but not limited to) relatively more limited in input and/or display capabilities. For the embodiments, client device 102 is communicatively coupled to server 112 via communication connection 122. Server 112 is configured with input/query processing unit 114 incorporated with the teachings of the present invention (hereinafter, simply “query processing unit”). As will be described in more detail below, query processing unit 114 is in particular configured to make data access from a client device 102 that may be limited in input and/or display capabilities, more user friendly. Specifically, in various embodiments, query processing unit 114 is configured to enable a user to input and submit a query expressed in a simple-natural, pseudo-natural or mixed-natural statement. Further, in various embodiments, query processing unit 114 is configured to return a more concise application or domain filtered response to the user or another user/application.

The term “simple-natural” language statement refers to a statement expressed using the words of a single language, e.g. an English statement like “Is there any French restaurant in uptown Manhattan?” formed with words of the English language, or a Chinese statement constituted with Chinese characters/words “hanzi”. The term “pseudo-natural” language statement refers to a statement having words of one language (phonetically) formed using language elements of another language (e.g. in accordance with a phonic system), such as a statement containing Chinese words phonetically formed using English alphabets in accordance with the pinyin (phonetic spelling) system, e.g. “Huangpu qu you mei you Faguo fandian” (meaning “Is there a French restaurant in HuangPu district?”) “HuangPu” is a proper name like “Manhattan”. The term “mixed-natural” language statement refers to a statement having words of one language and words of at least another language (one or more of which may be (phonetically) formed using language elements of another language (e.g. in accordance with a phonic system)), such as a statement having English words and “Chinese words” formed using English alphabets in accordance with the pinyin (phonetic spelling ) system, e.g. “Is there a Faguo (French) fandian (restaurant) in HuangPu qu?” or Is there a Faguo (French) fandian (restaurant) in HP qu?” (where HP is an acronym of HuangPu). Another example of “mixed-language” is a statement with “hanzi” and pinyin (or pinyin acronym or other Romanization methods). Still another example of “mixed-language” is a statement with Chinese (hanzi or pinyin), French and English words (and optionally, one or more of these words in acronym).

Note that by allowing the various modes or types of natural language input/query, including the employment of acronyms, various embodiments are able to fully resolve and process inputs/queries expressed entirely in acronyms, e.g. “fg fd hpq” for the example of “Faguo fandian Huangpu qu”. One of ordinary skill in the art would appreciate the significant amount of keystroke savings from such an input, as well as the significant amount of reduction in output (when compared to not understanding the input/query properly).

Still referring to FIG. 1, in various embodiments, as alluded to earlier, client device 102 may be a portable a portable communication device, such as a wireless mobile phone. In other embodiments, client device 102 may be a portable a portable computing device, such as a personal digital assistant or smartphones. In still other embodiments, client device 102 may be both. In yet still other embodiments, client device 102 may be a (smart) controller controlling e.g. a set-top box, a game console, and so forth. Regardless, in various embodiments, client device 102 may be configured to support text messaging, enabling an input/query (in particular, one expressed in a simple-natural, pseudo-natural or mixed-natural statement) to be entered/submitted via text messaging. In various embodiments, client device 102 is configured to support the Short Messaging Service (SMS) or Multimedia Messaging Service (MMS), enabling an input/query (in particular, one expressed in a simple-natural, pseudo-natural or mixed-natural statement) to be entered/submitted via a SMS or MMS message. In still other embodiments, client device 102 may support WAP or Web based (as well as other) applications, through which the simple/pseudo/mixed-language inputs/queries may be entered and transmitted in accordance with any one of a number of communication protocols, including but not limited to HTTP, HTTPS, SMTP, SOAP and so forth. (WAP=Wireless Application Platform, HTTP=Hypertext Transmission Protocol, HTTPS=Hypertext Transmission Protocol Secure, SMTP=Simple Mail Transfer Protocol, and SOAP=Simple Object Access Protocol.)

While the present invention is particularly helpful to client device 102 with relatively more limited in input and/or display capabilities, the invention is not so limited, in alternate embodiments, the invention may be practiced with client devices that are not limited in input and/or display capabilities, such as a conventional laptop and/or desktop computers.

Continuing to refer to FIG. 1, in various embodiments, server 112 may be an enterprise server, available from any one of a number of server manufacturers. In other embodiments, server 112 may be a cluster of computing devices, proximally located and coupled to each other via a local area network, or geographically dispersed, coupled to each other via a wide area network. In still other embodiments, server 112 may be a massively parallel computing system comprising of multiple processor nodes.

In various embodiments, communication connection 122 may be a “connection” over a local serial or parallel coupling. In other embodiments, communication connection 122 may be a “connection” over a local serial bus. In still other embodiments, communication connection 122 may be a “connection” over a local or wide area network, including a wide area network, that spans one or more wireless and/or wireline based voice and/or data networks.

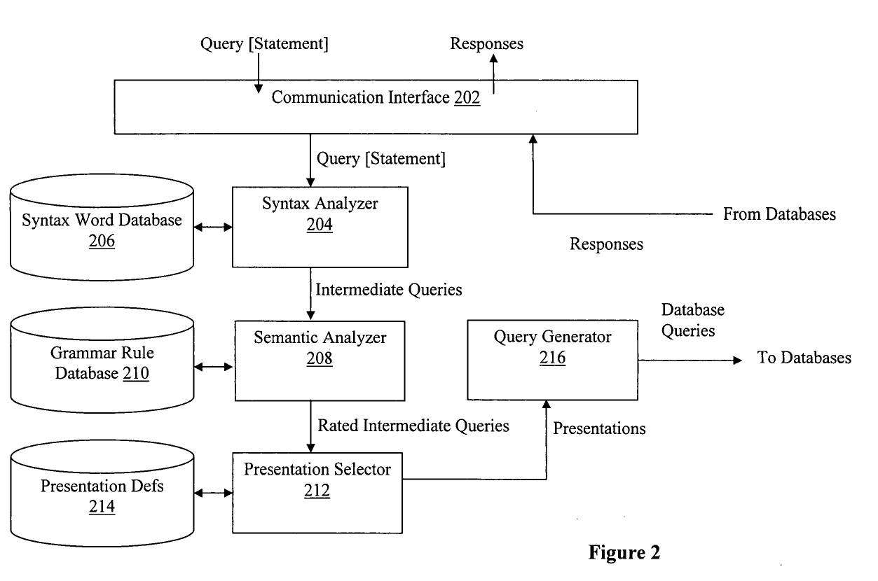

Referring now to FIG. 2, wherein query processing unit 114 of FIG. 1, in accordance with various embodiments, is illustrated in further details. As illustrated, for the embodiments, query processing unit 114 includes communication interface 202, syntactical analyzer 204, syntax word database 206, semantic analyzer 208, grammar rule database 210, presentation selector 212, presentation database 214, and query generator 216, coupled to each other as shown. In alternate embodiments, these elements may be coupled in other manners.

Communication interface 202 is configured to receive an input/query expressed in a simple-natural language, pseudo-natural language or mixed-natural language statement (hereinafter “statement”), and return a concise response to the input/query. As described earlier, in various embodiments, the response is an application or domain filtered, such that the response is more user friendly for client device 102 with limited display capabilities. The terms “application” and “domain” as used herein may be generally considered synonymous, unless the context of certain specific usages clearly indicate they are not. Examples of an application or domain are “Traffic Info Application/Domain”, “Restaurant Info Application/Domain”, and so forth. Still other examples of applications or domains are: Shops/Stores, Famous sites/attractions, Stocks quotes, Ringtones, Music, Video, Games, Horoscopes, News, and so forth.

Syntactical analyzer 204, coupled to communication interface 202, is configured to analyze the received statement, employing syntax words stored in syntax word database 206, to generate one or more intermediate queries. In various embodiments, each syntax word stored in syntax word database 206 comprises a simple-natural or pseudo-natural word (or its acronym), a symbol, and a type. In various embodiments, the type is domain dependent, and may map to a data variable in a data content database. For examples, syntax database 206 may have the following syntax words (a) {Faguo, FG, Country} where “Country” is the type for the symbol “FG” in a TrafficInfo Application/Domain (Faguo is the pinyin equivalent of France or French), (b) {Faguo, FG, Cuisine} where “Cuisine” is the type for the same symbol “FG” in a Restaurant Application/Domain.

Thus, assuming syntactical database 206 further includes a syntax word [HuangPu, HPQ, County], in response to the receipt of the mixed-natural language sentence “I want to know a Faguo restaurant in HuangPu district”, syntactical analyzer 204 (depending on the syntax words stored in syntactical database 206) may output at least two intermediate queries

1. For TrafficInfo Application: I want to know a [Faguo, FG, Country] restaurant in [HuangPu, HPQ, Region] district.

2. For RestaurantInfo Application: I want to know a [Faguo, FG, Cuisine] restaurant in [HuangPu, HPQ, Region] district.

In practice, depending on the number of applications or domains supported, syntax database 206 typically has hundreds, thousands or even hundreds of thousands of such syntax words (especially, when multitudes of acronyms are supported).

Continuing to refer to FIG. 2, semantic analyzer 208, coupled to syntax analyzer 204, is configured to analyze the intermediate queries, employing grammar rules stored in grammar database 210, to rate the intermediate queries based at least in part on how close the intermediate queries match the grammar rules, if any.

For example, continuing with the earlier exemplary mixed-natural language query, assuming semantic database 210 includes the following grammar rules

1. The rule for TrafficInfo : (‘From’)(Address+)(\w+)(County+)(\w+)(City+)(\w+)(State+)(\w+)(Country+)(w+)(‘To’)(Address+)(\w+)(County+)(\w+)(City+)(\w+)(State+)(\w+)(Country+)(\w+)

2. The rule for RestaurantInfo: (\W+)(\w+)(Series+)(\w+)(‘Restaurant’+)(\w+)(‘in’)(\w+)((RegionName|County|City)+)(\w+) and semantic analyzer 208 employs the following rating algorithm
Rate=NumberOfMatchedWords*1000+NumberOfMatchedCharacters+NumberOfMatchedDomainSyntax*1000,

semantic analyzer 208 would detect that the above exemplary intermediate queries match at least the above two grammar rules, and accord them a match rating of 2013 (2*1000+6+7) for the TrafficInfo Application/Domain, and 5025 (4*1000+6+10+2+7+1*1000) for the RestaurantInfo Application/Domain.

In practice, depending on the number applications/domains supported, grammar rule database 210 typically has hundreds or even thousands of such grammar rules, especially when multitude of pseudo and/or mixed inputs including acronyms are supported.

In alternate embodiments, other approaches to rating the intermediate queries with respect to their intended application or domain may be employed.

Still referring to FIG. 2, for the embodiments, presentation selector 212, coupled to semantic analyzer 208, is configured to select one or more presentation definitions (hereinafter, simply presentations) stored in presentation database 214, based at least on the rated intermediate queries. For the embodiments, each presentation is particularized for an application/domain, including a grammar rule matching threshold and an application/domain specific database query to be generated if the grammar rule matching threshold is met or exceeded. The grammar rule matching threshold denotes the minimum matching level an intermediate query must be rated, before the associated application/domain specific database query should be generated. Accordingly, the response returned may be more concise, application or domain specific.

In various embodiments, the application/domain specific database queries may be SQL queries. In alternate embodiments, other database queries may be generated instead. In still other embodiments, the database queries need not be application/domain specific.

Referring to the earlier exemplary mixed-natural language query again, assuming presentation database 214 includes a presentation having a grammar rule matching threshold of >3000, and the associated domain (i.e. Restaurant Info Application) specific query is Select * From RestaurantInfo Where Cuisine=″″ And Region=“”,since the second intermediate query matches the Restaurant Info domain grammar rule in excess of the presentation threshold of 3000, presentation selection 212 selects the Restaurant Info presentation.

Query generator 216, coupled to the presentation selector 212, is configured to generate the database query or queries of the selected presentation or presentations, and submit the generated query or queries to various data content databases. Accordingly, for the earlier exemplary mixed-natural language query, on selection of the Restaurant Info presentation, query generator 216 generates the Restaurant Info domain specific database query, e.g. Select*From RestaurantInfo Where Cuisine=″FG″ And Region=“HPQ”,and submit it to one or more data content databases.

In response, the data content databases return any stored data that meet the query criteria. On receipt, communication interface 202 returns the data returned from the data content database or database(s) to the client device 102 from which the query was submitted. Accordingly, response to the client device 102 may be more particularized and concise. In alternate embodiments, the response may be (optionally) returned to another user or an application.

In various implementations, for certain applications/domains, to avoid overly particularize and return no response to the user, each presentation may specify the generation of more than one domain specific database query. Alternatively, in various implementations, similar presentations that call for generation of slightly different database queries that potentially provide more or less returns may also be included in presentation database 214. Accordingly, with such presentation or presentations, additional domain specific queries, such as

1. Select*From RestaurantInfo Where Cuisine=″FG″

2. Select*From RestaurantInfo Where Region=″HPQ″

may also be generated by query generator 216, and submitted to one or more data content databases.

Additionally, in alternate embodiments, all or a subset of the data content databases queried for responses may be disposed on server 112.

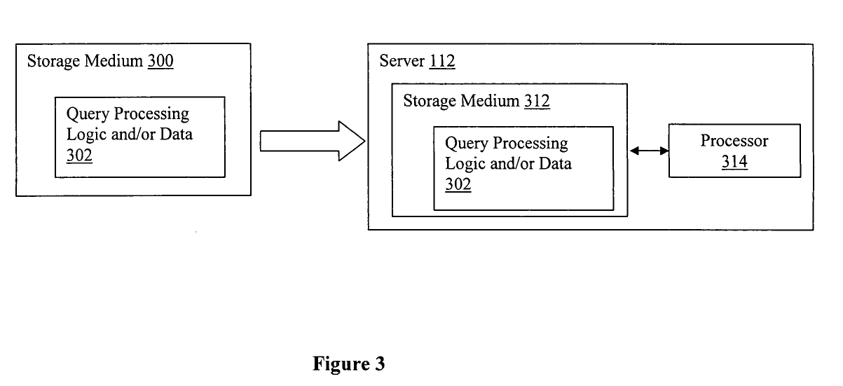

FIG. 3 illustrates an article of manufacture including a recordable/storage medium 300 readable by a computing device, in accordance with various embodiments. Recordable medium 300 has stored therein programming instructions implementing a software embodiment of the earlier described query processing logic 114. In various embodiments, recordable medium 300 may also include one or more of syntax database 206, grammar rule database 210, and presentation database 214.

For these embodiments, server 112 includes storage medium 302 to store at least a portion of a working copying of the programming instructions implementing the software embodiment of query processing logic 114, and at least one processor 304 coupled to storage medium 302 to execute the programming instructions. For those embodiments, where recordable medium 300 also includes one or more of syntax database 206, grammar rule database 210, and presentation database 214, storage medium 302 may also be employed to store the one or more of syntax database 206, grammar rule database 210, and presentation database 214.

Article 300 may, for example, be a diskette, a compact disk (CD), a DVD or other computer readable medium of the like. In other embodiments, article 300 may be a distribution server distributing query processing logic 114, via private and/or public networks, such as the Internet. In one embodiment, article 300 is a web server.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. A method comprising:
receiving from a portable computing or communication device an input or query expressed in a simple-natural, pseudo-natural or mixed-natural language statement;
syntactically processing the statement, employing a database of syntactical words having symbols and domain dependent types, to generate one or more intermediate queries;
semantically processing the intermediate queries, employing a plurality of grammar rules, to rate the intermediate queries with respect to how well the one or more intermediate queries match the grammar rules;
selecting one or more presentation definitions, each having a grammar rule matching threshold and a domain specific database query to be generated, based at least in part on the rated intermediate queries;
generating one or more domain specific database queries based at least in part on the selected one or more presentation definitions;
submitting the generated domain specific database queries against one or more databases; and
returning to the device answers returned from the one or more databases in response to the submission of the generated domain specific database queries.

2. The method of claim 1, wherein the receiving comprises receiving from the device an input or query expressed in a simple-natural language statement, the simple-natural language statement being either an English statement or a Chinese statement.

3. The method of claim 1, wherein the receiving comprises receiving from the device an input or query expressed in a pseudo-natural language statement having words or acronyms of a first language phonetically formed using language elements of a second language in accordance with a phonic system.

4. The method of claim 3, wherein the first language is Chinese, the second language is English, and the phonic system is pinyin.

5. The method of claim 1, wherein the receiving comprises receiving from the device an input or query expressed in a mixed-natural language statement having words of a first language, and words or acronyms of a second language phonetically formed using language elements of the first language in accordance with a phonic system.

6. A method comprising:
receiving from a computing or communication device with limited input and/or display capabilities, an input or query expressed in a simple-natural, pseudo-natural or mixed-natural language statement;
generating one or more domain specific database queries based at least in part on the received query expressed in a simple-natural, pseudo-natural or mixed-natural language statement;
submitting the generated domain specific database queries against one or more databases; and
returning to the computing or communication device answers returned from the one or more databases in response to the submission of the generated domain specific database queries.

7. The method of claim 6, wherein
the method further comprises
syntactically processing the statement to generate one or more intermediate queries,
semantically processing the intermediate queries to rate the intermediate queries,
selecting one or more presentation definitions, each having a rating threshold and a domain specific database query to be generated, based at least in part on the rated intermediate queries; and
the generating of the one or more domain specific database queries comprises generating the one or more domain specific database queries based at least in part on the selected presentation definition(s).

8. The method of claim 7, wherein the syntactical processing of the statement comprises syntactically processing the statement, employing a database of syntactical words having symbols and domain dependent types, to generate the one or more intermediate queries.

9. The method of claim 7, wherein the semantically processing of the intermediate queries comprises semantically processing the intermediate queries, employing a plurality of grammar rules, to rate the intermediate queries with respect to how well the one or more intermediate queries match the grammar rules, and the rating thresholds of the presentation definitions comprise grammar rule matching thresholds.

10. The method of claim 6 wherein the receiving comprises receiving from the computing or communication device an input or query expressed in a pseudo-natural language statement having words of a first language phonetically formed using language elements of a second language in accordance with a phonic system.

11. A method comprising:
receiving an input or query expressed in a pseudo-natural or mixed-natural language statement;
generating one or more database queries based at least in part on the received query expressed in a pseudo-natural or mixed-natural language statement;
submitting the generated database queries against one or more databases; and
returning answers returned from the one or more databases in response to the submission of the generated database queries.

12. The method of claim 11, wherein
the method further comprises
syntactically processing the statement to generate one or more intermediate queries,
semantically processing the intermediate queries to rate the intermediate queries,
selecting one or more presentation definitions, each having a rating threshold and a database query to be generated, based at least in part on the rated intermediate queries; and
the generating of the one or more database queries comprises generating the one or more database queries based at least in part on the selected presentation definition(s).

13. The method of claim 12, wherein the syntactical processing of the statement comprises syntactically processing the statement, employing a database of syntactical words having symbols and domain dependent types, to generate the one or more intermediate queries.

14. The method of claim 12, wherein the semantically processing of the intermediate queries comprises semantically processing the intermediate queries, employing a plurality of grammar rules, to rate the intermediate queries with respect to how well the one or more intermediate queries match the grammar rules, and the rating thresholds of the presentation definitions comprise grammar rule matching thresholds.

15. The method of claim 12 wherein the presentation definitions and the presentation definitions' database queries to be generated are domain specific.

16. The method of claim 11, wherein the input or query is received for an application selected from the group consisting of a traffic information application, a restaurant information application, a shopping information application, a famous sites/attractions information application, a news application, a stock quote application, a music application, a video application, a game application, and a ringtone application.

17. The method of claim 11, wherein the input or query is received in accordance with a messaging or communication protocol selected from the group consisting of short messaging service, multimedia messaging service, hypertext transmission protocol, hypertext transmission protocol secure, simple mail transfer protocol and simple object access protocol.

18. An apparatus comprising
a communication interface to receive from a portable computing or communication device an input or query expressed in a simple-natural, pseudo-natural or mixed-natural language statement, and to return to the device a response to the input or query;
a syntax database having syntactical words having symbols and domain dependent types;
a syntax analyzer coupled to the communication interface and the syntax database to syntactically process the simple-natural, pseudo-natural or mixed-natural language statement to generate one or more intermediate queries;
a grammar database having grammar rules;
a semantic analyzer coupled to the grammar database to semantically process the intermediate queries to rate the intermediate queries with respect to how well the one or more intermediate queries match the grammar rules;
a presentation database having a number of presentation definitions, each having a grammar rule matching threshold and a domain specific database query to be generated;
a selector coupled to the presentation database to select one or more presentation definitions, based at least in part on the rated intermediate queries;
a generator coupled to the selector to generate one or more domain specific database queries based at least in part on the selected one or more presentation definitions, and to submit the generated domain specific database queries against one or more databases to generate the response.

19. The apparatus of claim 18 further comprising a processor coupled to and operate one or more of the syntax analyzer, the semantic analyzer, the selector and the generator.

20. An apparatus comprising
a communication interface to receive from a computing or communication device with limited input and/or display capability, an input or query expressed in a simple-natural, pseudo-natural or mixed-natural language statement, and to return to the portable computing or communication device a response to the input or query;
an input/query processing unit coupled to the communication interface to generate one or more domain specific database queries based at least in part on the simple-natural, pseudo-natural or mixed-natural language statement, and to submit the generated domain specific database queries against one or more databases to generate the response for the communication interface.

21. The apparatus of claim 20, wherein the input/query processing unit comprises:
a syntax database having syntactical words having symbols and domain dependent types;
a syntax analyzer coupled to the communication interface and the syntax database to syntactically process the simple-natural, pseudo-natural or mixed-natural language statement to generate one or more intermediate queries;
a grammar database having grammar rules;
a semantic analyzer coupled to the grammar database to semantically process the intermediate queries to rate the intermediate queries with respect to how well the one or more intermediate queries match the grammar rules;
a presentation database having a number of presentation definitions, each having a grammar rule matching threshold and a domain specific database query to be generated;
a selector coupled to the presentation database to select one or more presentation definitions, based at least in part on the rated intermediate queries; and
a generator coupled to the selector to generate one or more domain specific database queries based at least in part on the selected one or more presentation definitions, and to submit the generated domain specific database queries against one or more databases to generate the response.

22. An apparatus comprising
an interface to receive an input or query expressed in a pseudo-natural or mixed-natural language statement;
an input/query processing unit coupled to the interface to generate one or more database queries based at least in part on the pseudo-natural or mixed-natural language statement, and to submit the generated domain specific database queries against one or more databases to generate a response to the input or query.

23. The apparatus of claim 22, wherein the input/query processing unit comprises:
a syntax database having syntactical words having symbols and domain dependent types;
a syntax analyzer coupled to the communication interface and the syntax database to syntactically process the pseudo-natural or mixed-natural language statement to generate one or more intermediate queries;
a grammar database having grammar rules;
a semantic analyzer coupled to the grammar database to semantically process the intermediate queries to rate the intermediate queries with respect to how well the one or more intermediate queries match the grammar rules;
a presentation database having a number of presentation definitions, each having a grammar rule matching threshold and a database query to be generated;
a selector coupled to the presentation database to select one or more predefined presentation definitions, based at least in part on the rated intermediate queries; and
a generator coupled to the selector to generate one or more database queries based at least in part on the selected one or more presentation definitions, and to submit the generated database queries against one or more databases to generate the response.

24. A computer readable medium comprising programming instructions configured to program an apparatus to practice the method of claim 1.

25. A computer readable medium comprising programming instructions configured to program an apparatus to practice the method of claim 6.

26. A computer readable medium comprising programming instructions configured to program an apparatus to practice the method of claim 11.
